(19) United States
(12) Patent Application Publication
(10) Pub. No.: US 2007/0047470 A1
(43) Pub. Date: Mar. 1, 2007

(54) Algorithm for searching graphs and device for searching graphs using it

(76) Inventor: Fumihiro Okabe, Sagamihara (JP)

Correspondence Address: WENDEROTH, LIND & PONACK, L.L.P., 2033 K STREET N. W., SUITE 800, WASHINGTON, DC, 20006-1021, US

(21) Appl. No.: 11/511,446

(22) Filed: Aug. 29, 2006

(30) Foreign Application Priority Data
Sep. 1, 2005 (JP) 2005-252962

(51) Int. Cl. H04L 12/28

(52) U.S. Cl. 370/255

(57) ABSTRACT

In order to provided algorithm for searching graphs and a device for searching graph into which a new concept for solving a disadvantage arisen by using proof numbers or disproof numbers in an AND/OR graph construction is taken, algorithm according to the present invention which searches directed graphs in which OR nodes having at least one choice or more choices desired to reach to solution and AND nodes necessary to reach all choices to the solution are appeared alternately from a starting point to the solution, further comprising: a calculating step for calculating branch numbers of routes except for a specific route reaching at least from the starting point to an optional node at a specific node in the AND nodes or the OR nodes accompanying with said specific route.

### BACKGROUND OF THE INVENTION

The present invention relates to algorithm for searching graphs performed by a computer and a device for searching graphs using it.

Up to now, searches for games or puzzles such that two final evaluations (“checkmate (true)” and “not-checkmate (false)” or “win” or “loss” and the like) exist like Tsume-Shogi (note that the Tsume-Shogi is a game that an attacker searches a route to a checkmate in Shogi (a Japanese chess)) were generalized as a search for an AND/OR graph in a field of artificial intelligence. The AND/OR graph has two kinds of nodes such as an AND node or an OR node. The AND node is a node which is suited to a position of a king turn in Tsume-Shogi and that all branches in the node are converged to a checkmate is required. The OR node is a node which is suited to a position of an attacker turn and in which any one of branches in the node is expected to reach the checkmate. Generally, solving Tsume-Shogi is an action that: in the case that a position of a given problem regards as a base node and a checkmate position which is a desired end node regards as a “solution”, at least one branch or more is/are selected at the OR nodes and all branches are selected at the AND nodes, and then an AND/OR graph (a solution graph) that all end nodes are constituted of checkmate positions is specified and confirmed. Generally, when we thought to search a solution graph included in thus AND/OR graphs in a small amount of search behavior, how to search a branch converged to the checkmate finally in every OR node or a node converged to the not-checkmate finally in every AND node is the key to the solution of the case. Recently, a concept of a proof number or a disproof number was introduced as an index of priority for selecting branches in every node.

A monograph “Algorithm 75-2 ‘Application of df-pn Algorithm to a Solve Tusme-Shogi Program’ Nov. 10, 2000 discloses that proof number and disproof number are set to every node. Here, the proof number is a minimal value of the number of front nodes each of which must indicate that it becomes “true” in order to make a final evaluation value of the node become “true”, the disproof number is a minimal value of the number of front nodes each of which must indicate that it becomes “false” in order to make a final evaluation value become “false”.

A concrete calculation method for the proof number and the disproof number are carried out reflexively as follows.

1. A node n is a front node

(a) A final evaluation is “true”.
n.pn=0
n.dn=∞

(b) A final evaluation is “false”.
n.pn=∞
n.dn=0

(c) A final evaluation is obscure.
n.pn=1
n.dn=1
   2. A node n is an inner node.

(a) The n is an OR node.
n.pn=a minimum of pn of the dependent nodes
n.dn=a sum of dn of the dependent nodes

(b) The n is an AND node.
n.pn=a sum of pn of the dependent nodes
n.dn=a minimum of dn of the dependent nodes

Due to the above, it is desired to select a node with a minimum of the proof number in the OR node and to select a node with a minimum of the disproof number in the AND node. In an example of the Tsume-Shogi, as the proof number is larger, difficulty for checkmating is higher, so that it is necessary to select a move such as to be easy to reach to the checkmate in the OR node, as a result it is important to select a minimum move (node) with a minimum of the proof number. On the contrary, in the AND node, as it is necessary to select a move such as to be easy to reach to the not-checkmate, it is important to select a move (node) with a minimum of the disproof number.

Besides, JP 7-219920 A discloses a method for processing to dissolve an optimization problem having a first progress for discovering a part of solution by a deterministic method and a second progress for discovering a rest solution by applying a genetic algorithm for a solution space except for the part of solution discovered in the first progress.

However, the algorithm in the case of Tusme-Shogi as disclosed in the above monograph is generalized as an AND/OR directed graph having DAG (Directed A cycled Graph) or a closed route (Cycle). In the case of considering searches for a graph construction including the DAG, it is possible for plural routes to reach to the same node, so that disadvantage such that the proof number and the disproof number are counted redundantly, and that the search takes a back seat to another search though an amount of search until reaching to the solution is small is arisen. Actually, though a method that constitution for detecting a double count of the proof number and the disproof number particularly is made and correction is added is known, the general solution has not been reached in the present circumstances because the processing is complicated in this method.

Accordingly, the present invention is to provide algorithm for searching graphs and a device for searching graphs which a new concept for solving the above disadvantage arising by using a concept of the proof number and the disproof number in analytical algorithm of the AND/OR graph construction.

### SUMMARY OF THE INVENTION

Thus, the present invention is to provided with algorithm for searching graphs which searches directed graphs in which OR nodes having at least one choice or more choices desired to reach to solution and AND nodes necessary to reach all choices to the solution are appeared alternately from a starting point to the solution, further comprising: a calculating step for calculating branch numbers of routes except for a specific route reaching at least from the starting point to an optional node at a specific node in the AND nodes or the OR nodes accompanying with said specific route.

Besides, it is desired that the algorithm for searching graphs further comprises a route producing step for producing all routes whose branch numbers are not more than specific thresholds at the specific node; a judgment step for confirming whether every route produced in the route producing step reaches to the solution or not; and a threshold renewing step for setting a larger value to the thresholds at the specific node when the specific route does not reach to the solution.

Furthermore, it is preferred that the calculating step for calculating unsolved branch numbers except for the specific route in a specific OR node accompanying with the specific route from the starting point to the optional node as OR branch numbers, and unsolved branch numbers except for the specific route in a specific AND node accompanying with the specific route from the starting point to the specific node as AND branch numbers.

Moreover, algorithm according to the present invention is to comprise, in algorithm for searching graphs which searches directed graphs in which OR nodes having at least one choice or more choices desired to reach to solution and AND nodes necessary to reach all choices to the solution are appeared alternately from a starting point to the solution, and further to comprise one or both of a calculating step for calculating unsolved branch numbers except for the specific route in a specific OR node accompanying with the specific route from the starting point to the optional node as OR branch numbers and a calculating step for calculating unsolved branch numbers except for the specific route in a specific AND node accompanying with the specific route from the starting point to the specific node as AND branch numbers; a route producing step for producing all routes one or both of the OR branch numbers and the AND branch numbers of which are not more than specific thresholds at the specific OR node or the specific AND node; a judgment step for confirming whether every route produced in the route producing step reaches to the solution or not; and a threshold renewing step for setting a larger value to the thresholds at the specific node again when the specific route does not reach to the solution.

According to the present invention, since one or both of the OR branch number or the AND branch number is made a criterion for selecting route, even if the algorithm has not only the AND/OR graph structure but also a graph structure including many DAGs, an effect such that it is possible to find a solution in a little searching cost can be successful.

### BRIEF DESCRIPTION OF THE DRAWINGS

FIG. 1 is a flowchart diagram of algorithm for searching graphs according to the present invention;

FIG. 2 is an explanatory drawing showing a concept of an AND branch number and an OR branch number in the present invention;

FIG. 3 is an explanatory drawing showing an example of a chart due to the algorithm of the present invention;

FIG. 4 is an explanatory drawing showing an example of a chart due to the algorithm of the present invention;

FIG. 5 is an explanatory drawing showing an example of a chart due to the algorithm of the present invention;

FIG. 6 is an explanatory drawing showing an example of a chart due to the algorithm of the present invention; and

FIG. 7 is an explanatory drawing showing an example of a chart due to the algorithm of the present invention;

### THE PREFERRED EMBODIMENT OF THE INVENTION

Hereinafter, an embodiment of the present invention is explained. Here, an OR branch number obn and an AND branch number abn are defined as follows;

```
(an end node)
    obscurity: abn =1,  obn = 1
    true:  abn =0,  obn = ∞
    false:  abn =∞,  obn = 0
(an intermediate node)
OR node: abn = min (abn of the dependent nodes)
      obn = (selective obn) + (non-selective unsolved numbers)
AND node: abn = (selective abn) + (non-selective unsolved numbers)
      obn = min (obn of the dependent nodes)
```

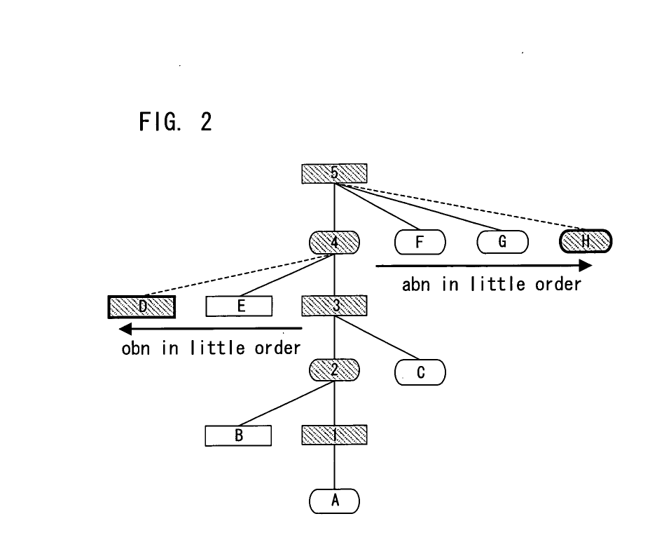

Note that a concept of the branch number according to the present invention is as shown in FIG. 2. In FIG. 2, reference numbers 1 to 5 are searching nodes, reference marks A to H are choices accompanying with searching nodes 1 to 5. Thus, the mark A is an unsolved branch in the OR node 1 and the mark B is a unsolved branch in the AND node 2. Similarly, the mark C is a unsolved branch in the OR node 3, the mark D is a solved branch in the AND node 4, the mark E is a unsolved branch in the AND node 4, the marks F and G are unsolved branches in the OR node 5, and the mark H is a solved branch in the OR node 5. Accordingly, the OR branch number in the OR node 5 is four due to the marks A, C, F and G, and the AND branch number in it is two due to the marks B and E. Besides, a large number is added to the solved nodes H and D so that the branch number of it exceeds a threshold. Accordingly, routes with smaller abn and obn are selected in turn. Note that the branch number in every searching point in the embodiment shown in FIG. 2 is as follows.

TABLE 1

| Searching | | |
|---|---|---|
| point | obn | abn |
| 5 | obn(4) + 2 | abn(4) |
| 4 | obn(3) | abn(3) + 2 |
| 3 | obn(2) + 1 | abn(2) |
| 2 | obn(1) | abn(1) + 1 |
| 1 | 1 | 1 |

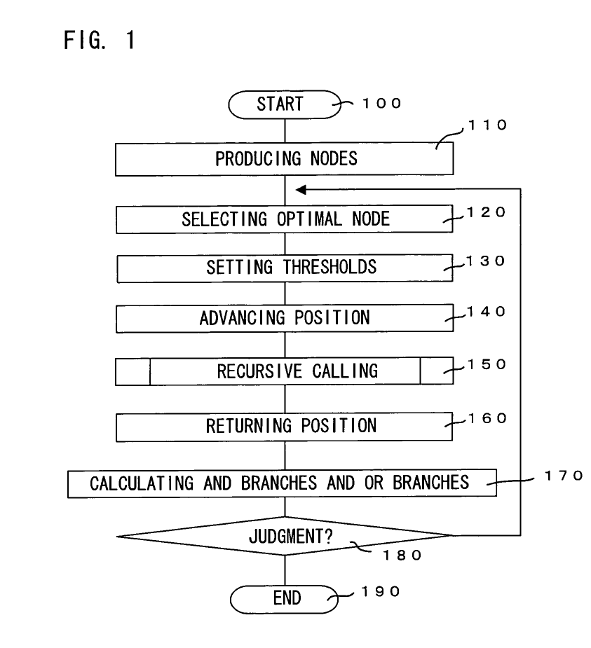

In this embodiment, sufficiently large value RBN is set as a threshold OBN in the OR branch number and as a threshold ABN in the AND branch number in a route position. By setting the route position as a search starting point, according to the following definitions and rules, along the flowchart shown in FIG. 1, searching of every graph node is repeated. Note that a repeat deepening condition according to the present invention is as follows.

```
(definition)
n: searching node
obn (n): OR branch number
abn (n): AND branch number
c1,......, ck, cn, .........., cu: dependent node
in the case of OR node:
abn (c1) ≦....≦ abn (ck), abn (cn) = ,......, = abn (cu) = ∞
in the case of AND node:
obn (c1) ≦....≦ obn (ck), obn (cn) = ,......, = obn (cu) = ∞
OBN: a threshold of the OR branch number
ABN: a threshold of the AND branch number
(selected move)  always c1
(renewing thresholds)
OR node: ABN′ = min (abn (c2) + 1, ABN)
        OBN′ = OBN − k + 1
AND node: ABN′ = ABN − k + 1
          OBN′ = min (obn (c2) + 1, OBN)
(return condition)
OBN≦ obn (n) or ABN ≦ abn (n)
(repeat deepening condition)
OBN > obn (n) and ABN > abn (n)
```

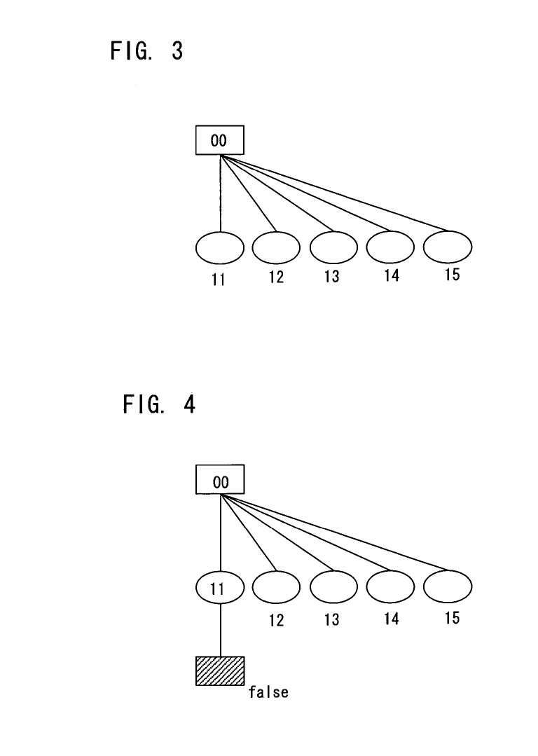

Explaining the flowchart shown in FIG. 1 by using FIG. 3 for example here, at first in a step 100, a searching node 00 and thresholds OBN and ABN are given. Here, in the case that the mark 00 is a non-searching node, obn (00)=1 and abn (00)=1 are given. Next, in a step 110, obn (11)=1, abn (11)=1, . . . , obn (15)=1 and abn (15)=1 are given as starting values respectively. Then, in a step 120, an optimal node is selected. In this case, because the node 00 is an OR node having all dependent nodes with abn=1, the selection is optional. Here, a node 11 is selected. In a next step 130, thresholds ABN′ and OBN′ given to the node 11 are determined, so that ABN′=2, and OBN′=RBN−4 are given according the above-mentioned definition. Next, in a step 140, a position is advanced to the selected node 11, and then in a step 150, recursive call of the present algorithm is performed in the thresholds ABN′ and OBN′. Here, the branch numbers abn (11) and obn (11) not less than either ABN′ or OBN′ as a return value is gained. Next, in a step 160, the node is returned to the node 00, the branch numbers obn (00) and abn (00) in the node 00 are calculated based on the result of the abn (11) and the obn (11) in a step 170. Next, in a step 180, a comparison between the branch numbers obn (00) and abn (00), and, the thresholds OBN and ABN respectively, if the branch numbers obn (00) and abn (00) are less than the thresholds, operation returns to the step 120 to continue the search, or if any one of the branch numbers is not less than the corresponding threshold, operation moves to a step 190 to terminate searching. Here, when the searching node is a route node, if thoroughly large value is given to the thresholds, in principle, the search is terminated in either result of true: abn=0 and obn=∞ or false:abn=∞ and obn=0.

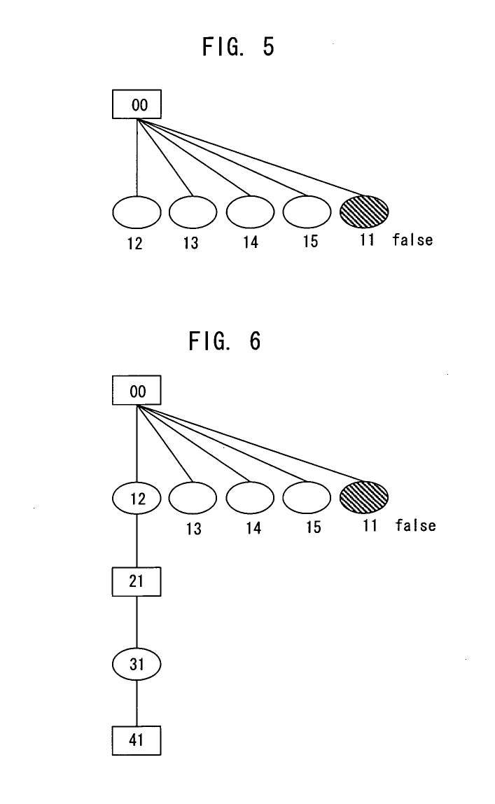

Next, a progress for introducing solution due to the present algorithm is explained by using FIGS. 3 to 7 and following stages. At first, in FIG. 3, the nodes 11 to 15 are produced as dependent nodes from the OR node 00 of the route. Because these nodes 11 to 15 are unsolved, obn=1 and abn=1 are given to every dependent node, the node 11 is selected as an optimal node provisionally, OBN′=RBN−4 and ABN′=2 are given as thresholds and the operation moves to the node 11. Next, in FIG. 4, an OR node is produced under the node 11. If the OR node is a false, obn=0 and abn=∞ are given to the node 11. Next, the operation returns to the node 00 again, obn (00)=4 and abn (00)=1 are calculated, and then re-selection of the optimal node is performed from the nodes 1 to 15 as shown in FIG. 5. Here, since abn of every node except for the node 11 is 1, the node 12 is selected provisionally here. Besides, the thresholds given to the selected node 12 are ABN′=2 and OBN′=RBN−3 because the node 11 is solved.

FIG. 6 shows an example such that an OR node 21, an AND node 31 and an OR node 41 have one choice in every position respectively in search from the AND node 12. In this case, the thresholds of the OR node 00 are succeeded to the dependent nodes as they are.

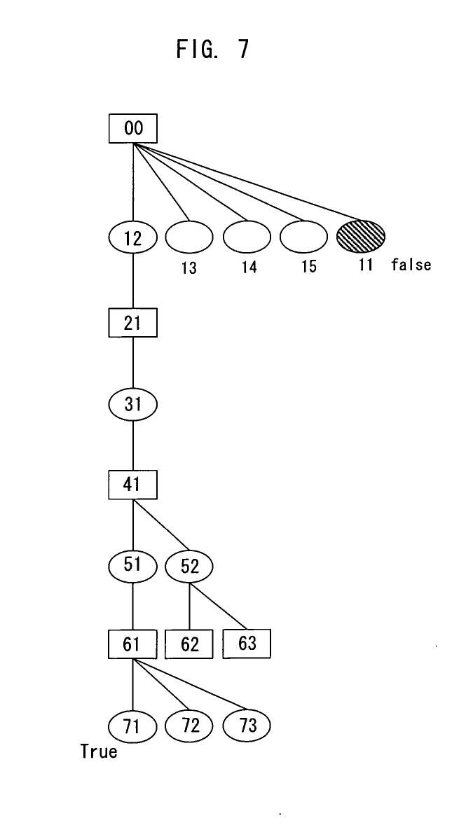

Next, as shown in FIG. 7, in search in the OR node 41, it is searched that two AND nodes 51 and 52 exist, that one node 61 exists in the AND node 51, that two OR nodes 62 and 63 exist in the AND node 52, further that three AND nodes 71, 72 and 73 exist in the OR node 61 and that one of them is “true”, and the operation is completed.

Because it becomes possible to process analysis of the AND/OR graph structure smoothly and for a short time and reach the solution by installing the algorithm according to the present invention in a computer as one of various algorithms constituting artificial intelligence, the ability of the artificial intelligence can be increased and it is possible to construct an idea closer to a human idea.

What is claimed is:

1. Algorithm for searching graphs which searches directed graphs in which OR nodes having at least one choice or more choices desired to reach to solution and AND nodes necessary to reach all choices to said solution are appeared alternately from a starting point to said solution, further comprising:
a calculating step for calculating branch numbers of routes except for a specific route reaching at least from said starting point to an optional node at a specific node in said AND nodes or said OR nodes accompanying with said specific route.

2. Algorithm according to claim 1, further comprising:
a route producing step for producing all routes whose branch numbers are not more than specific thresholds at said specific node;
a judgment step for confirming whether every route produced in said route producing step reaches to said solution or not; and
a threshold renewing step for setting a larger value to said thresholds at said specific node when said specific route does not reach to said solution.

3. Algorithm according to claim 1, wherein:
said calculating step for calculating unsolved branch numbers except for said specific route in a specific OR node accompanying with said specific route from said starting point to said optional node as OR branch numbers, and unsolved branch numbers except for said specific route in a specific AND node accompanying with the said specific route from said starting point to said specific node as AND branch numbers.

4. Algorithm according to claim 2, wherein:
said calculating step for calculating unsolved branch numbers except for said specific route in a specific OR node accompanying with said specific route from said starting point to said optional node as OR branch numbers, and unsolved branch numbers except for said specific route in a specific AND node accompanying with said specific route from said starting point to said specific node as AND branch numbers.

5. Algorithm for searching graphs which searches directed graphs in which OR nodes having at least one choice or more choices desired to reach to solution and AND nodes necessary to reach all choices to said solution are appeared alternately from a starting point to said solution, comprising:
one or both of a calculating step for calculating unsolved branch numbers except for said specific route in a specific OR node accompanying with said specific route from said starting point to said optional node as OR branch numbers and a calculating step for calculating unsolved branch numbers except for said specific route in a specific AND node accompanying with said specific route from said starting point to said specific node as AND branch numbers;
a route producing step for producing all routes one or both of said OR branch numbers and said AND branch numbers of which are not more than specific thresholds at said specific OR node or said specific AND node;
a judgment step for confirming whether every route produced in said route producing step reaches to said solution or not; and
a threshold renewing step for setting a larger value to said thresholds at said specific node again when said specific route does not reach to said solution.

6. A device for using algorithm for searching graph according to claim 1.

7. A device for using algorithm for searching graph according to claim 2.

8. A device for using algorithm for searching graph according to claim 3.

9. A device for using algorithm for searching graph according to claim 4.

10. A device for using algorithm for searching graph according to claim 5.
